(19) United States
(12) Patent Application Publication
(10) Pub. No.: US 2025/0124267 A1
(43) Pub. Date: Apr. 17, 2025

(54) MULTI-LABEL SHALLOW NEURAL NETWORK MODEL FOR TABULAR DATA

(71) Applicant: PAYPAL, INC., San Jose, CA (US)

(72) Inventors: Satyabrata Mishra, Bengaluru (IN); Vignesh Ravichandran, Ambasamudram (IN)

(21) Appl. No.: 18/527,557

(22) Filed: Dec. 4, 2023

(30) Foreign Application Priority Data
Oct. 13, 2023 (IN) 202311069142

(51) Int. Cl. G06N 3/0495; G06N 3/08; G06Q 40/03

(52) U.S. Cl. CPC G06N 3/0495; G06N 3/08; G06Q 40/03

(57) ABSTRACT

The disclosed computer-implemented method includes normalizing tabular data corresponding to a query target, and inputting the normalized tabular data into a shallow neural network corresponding to a fully-connected three-layer model comprising an input layer, a hidden layer, and an output layer. Normalizing the tabular data may replace feature detection for the shallow neural network. The method may further include predicting a plurality of classifications for the query target, wherein a plurality of nodes of the output layer respectively correspond to the plurality of classifications. Various other methods, systems, and computer-readable media are also disclosed.

### BACKGROUND

Machine learning models such as neural networks are often trained to accept various input parameters, producing an output value representing a label or classification. The output value may be a binary value (e.g., 1 or 0, or true or false) that the inputs belong to the label or classification, or may correspond to a probability (e.g., range of values) that the inputs belong to the label or classification. Some neural networks may have an output layer with multiple label/category outputs such that a given input set (e.g., input layer) may produce/predict multiple categorizations. Neural networks also often include various hidden layers between the input and output layers, each requiring significant processing for producing values for a next layer. The neural networks may be trained using training data that correlates input parameter values with correct labels/categories.

With appropriate training data, neural networks may be applied to various contexts such as computer vision (e.g., image recognition), natural language processing (NLP), etc. In such contexts, the input data may be complex, requiring the neural networks to use multiple hidden layers for feature extraction/analysis such that these neural networks may include many nodes and layers. In other contexts, the input data may be tabular data (e.g., data that may be organized into tables having rows represent observations and columns representing attributes for the observations). For example, financial categorizations/predictions may use tabular data. However, machine learning models for tabular data are often restricted to a single label such that multiple machine learning models would be necessary for multiple labels. In addition, such machine learning models are often not optimized for use with tabular data. Thus, there is a need for a machine learning model trained for multiple labels and further made more efficient for use with tabular data.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for a multi-label shallow neural network for tabular data.

FIG. 2 is a block diagram of an exemplary network for a multi-label shallow neural network for tabular data.

FIG. 3 is a diagram of credit determination based on risk.

FIG. 4 is a diagram of an exemplary simplified neural network.

FIG. 5 is a diagram of an exemplary multi-label shallow neural network.

FIG. 6 is a diagram of exemplary tabular training data.

FIG. 7 is a graph of exemplary multi-label output.

FIG. 8 is a flow diagram of an exemplary method for using a multi-label shallow neural network for tabular data.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a multi-label shallow neural network for tabular data. As will be explained in greater detail below, implementations of the present disclosure normalize tabular data of a query target, and input the normalized tabular data into a shallow neural network to predict multiple classifications (or labels) for the query target. By using a shallow neural network that may include an input layer, a hidden layer, and an output layer, and further normalizing the tabular data for input, the systems and methods described herein may advantageously improve the functioning of a computer itself by more efficiently processing multiple classifications. For example, a single shallow neural network that predicts multiple classifications may use less computational resources such as memory, processor cycles, storage, bandwidth, etc. than computational resources required for a separate machine learning model for each of the classifications. Reducing layers may reduce a complexity of the neural network, particularly for multiple output classifications, to more efficiently predict the multiple classifications. For instance, a reduced number of hidden layers may reduce an overall number of calculations, particularly for calculations between input and output layers of a neural network. The systems and methods provided herein may further improve the technical field of machine learning by providing more efficient configurations for processing tabular data.

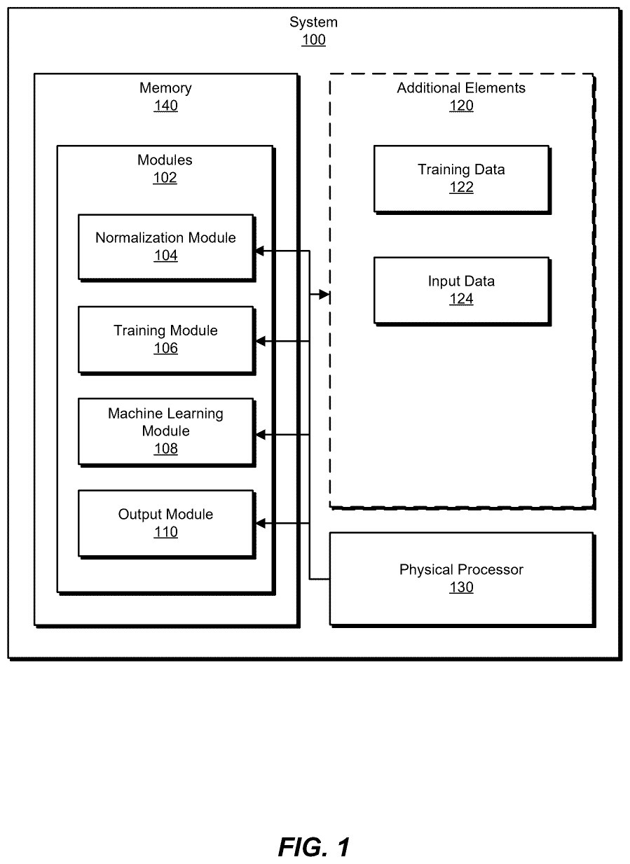

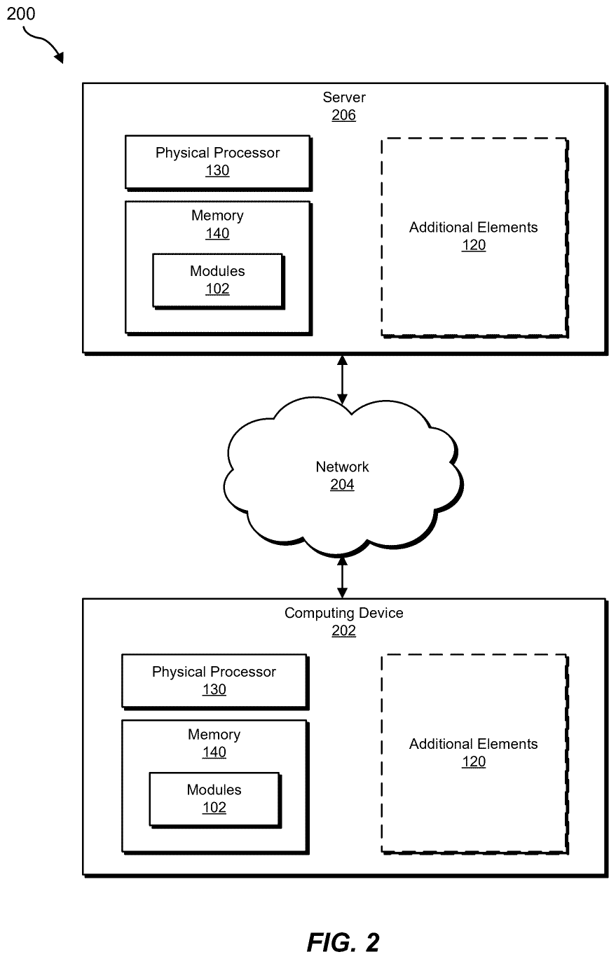

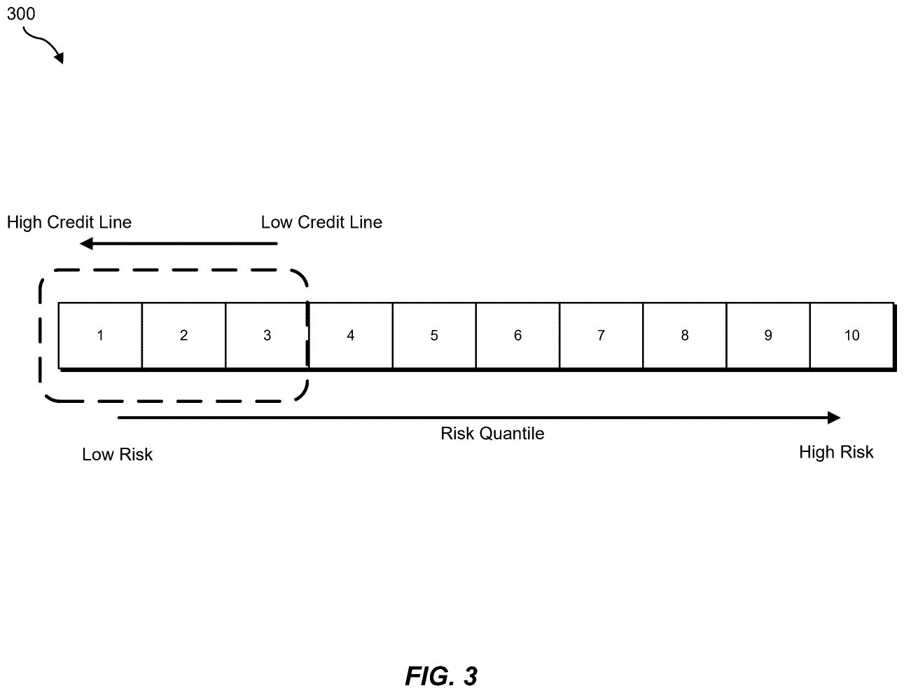

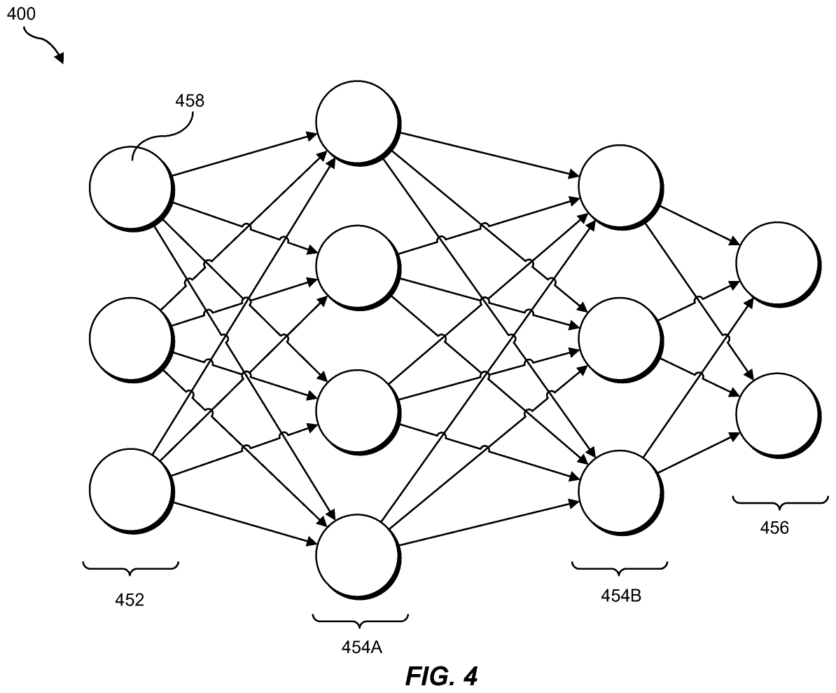

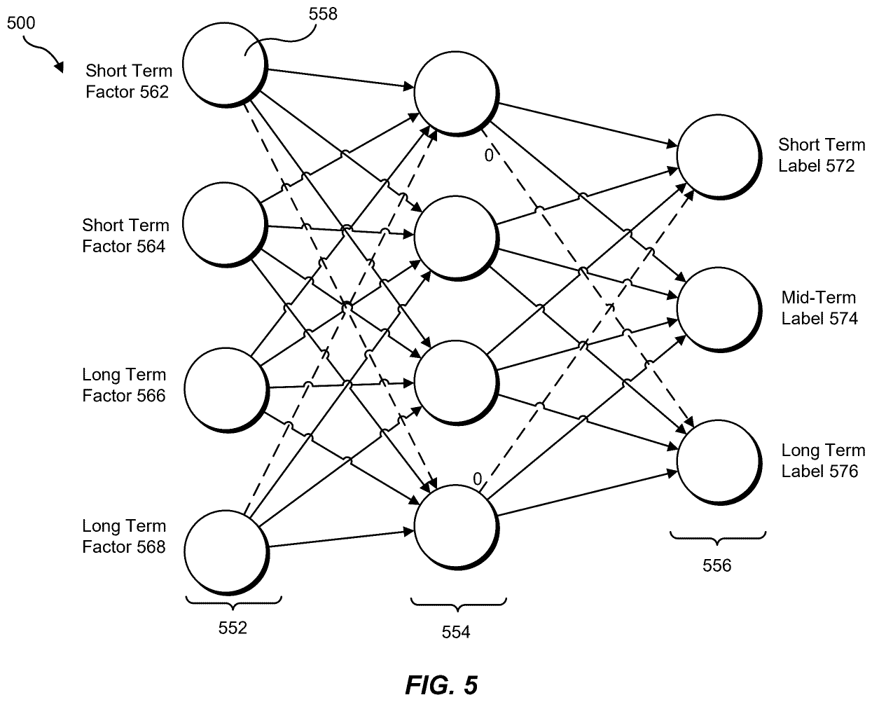

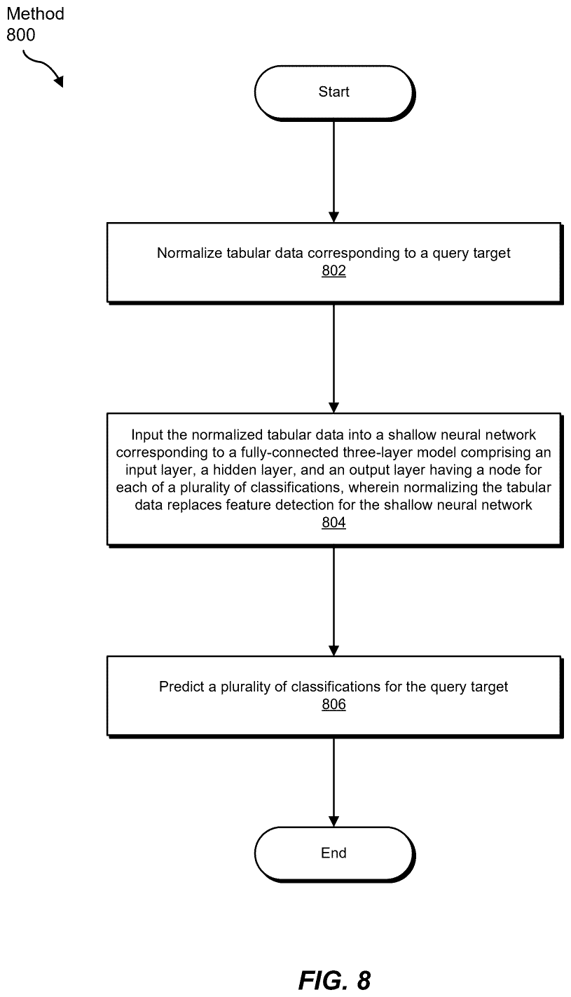

The following will provide, with reference to FIGS. 1-8, detailed descriptions of multi-label shallow neural networks for tabular data. Detailed descriptions of example neural networks will be provided in connection with FIGS. 4 and 5. In addition, detailed descriptions of example financial contexts and associated training data will be provided in connection with FIGS. 3, 6, and 7. Detailed descriptions of corresponding computer-implemented methods will also be provided in connection with FIG. 8. In addition, detailed descriptions of an example computing system and network architecture capable of implementing one or more of the implementations described herein will be provided in connection with FIGS. 1 and 2 respectively.

FIG. 1 is a block diagram of an example system 100 for a multi-label shallow neural network for tabular data. As illustrated in this figure, example system 100 includes one or more modules 102 for performing one or more tasks. As will be explained in greater detail herein, modules 102 include a normalization module 104, a training module 106, a machine learning (ML) module 108, and an output module 110. Although illustrated as separate elements, one or more of modules 102 in FIG. 1 may represent portions of a single module or application.

In certain implementations, one or more of modules 102 in FIG. 1 may represent one or more software applications or programs that, when executed by a computing device, causes the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 206). In some implementations, a module may be implemented as a circuit. One or more of modules 102 in FIG. 1 may also represent all or portions of one or more special-purpose computers configured to perform one or more tasks.

As illustrated in FIG. 1, example system 100 also includes one or more memory devices, such as memory 140. Memory 140 generally represents any type or form of volatile or non-volatile storage device or medium capable of storing data and/or computer-readable instructions. In one example, memory 140 stores, loads, and/or maintains one or more of modules 102. Examples of memory 140 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 also includes one or more physical processors, such as physical processor 130. Physical processor 130 generally represents any type or form of hardware-implemented processing unit capable of interpreting and/or executing computer-readable instructions. In one example, physical processor 130 accesses and/or modifies one or more of modules 102 stored in memory 140. Additionally, or alternatively, physical processor 130 executes one or more of modules 102 to train and use a multi-label shallow neural network for tabular data. Examples of physical processor 130 include, without limitation, microprocessors, microcontrollers, Central Processing Units (CPUs), graphical processing units (GPUs), Field-Programmable Gate Arrays (FPGAs) that implement softcore processors, Application-Specific Integrated Circuits (ASICs), systems on a chip (SoCs), portions of one or more of the same, variations or combinations of one or more of the same, and/or any other suitable physical processor.

As illustrated in FIG. 1, example system 100 also includes one or more additional elements 120, such as training data 122 and input data 124. Training data 122 and/or input data 124 may be stored on a local storage device, such as memory 140, or may be accessed remotely. Training data 122 represents tabular data such as user data of existing users, as will be explained further below. Input data 124 represents tabular data of a query target, such as user data of a target user, as will be explained further below.

Example system 100 in FIG. 1 may be implemented in a variety of ways. For example, all or a portion of example system 100 represent portions of example network environment 200 in FIG. 2.

FIG. 2 illustrates an exemplary network environment 200 implementing aspects of the present disclosure. The network environment 200 includes computing device 202, a network 204, and server 206. Computing device 202 may be a client device or user device, such as a desktop computer, laptop computer, tablet device, smartphone, or other computing device. Computing device 202 includes a physical processor 130, which may be one or more processors, memory 140, which may store data such as one or more of additional elements 120. In some implementations, computing device 202 represents a device connected to a financial data management system that may be used for financial and/or risk determinations.

Server 206 represents or includes one or more servers and/or other computing devices capable of training and/or running a multi-label shallow neural network for tabular data. In some examples, server 206 may also correspond to the financial data management system. Server 206 includes a physical processor 130, which may include one or more processors, memory 140, which may store modules 102, and one or more of additional elements 120.

Computing device 202 is communicatively coupled to server 206 through network 204. Network 204 represents any type or form of communication network, such as the Internet, and may comprise one or more physical connections, such as LAN, and/or wireless connections, such as WAN.

As described above, ML models such as neural networks may be used for making predictions (e.g., labels or classifications) based on various input parameters/data, which may be further used for decision making. In some contexts, a neural network may be trained for use in financial-related, risk-related and/or other user-related decisions, including but not limited to credit applications, fraud detection, etc.

FIG. 3 illustrates an example credit risk spectrum 300 that may be used for credit decisions, such as whether to approve a credit application of a user, how much credit to approve, etc. In some examples, credit risk spectrum 300 may correspond to quantiles based on an output from a machine learning model, such as linear regression based binary classification model or other model that may predict a single classification/label, namely a probability of default at a given future time frame (e.g., at 18 months or any future time frame). This model may use various input parameter or variables. For instance, for a target user, the input features may include target user data of the target user that is available from one or more sources including credit bureaus, internally available (e.g., based on the target user's financial activity), and/or submitted user application information. This target user data may correspond to short term user data indicative of short term risk factors, such as time (e.g., months, weeks, days, years, etc.) from opening a most recent account, a number of new accounts in a time frame (e.g., last 12 months or any other appropriate period of time), a number of revolving accounts with a certain (e.g., 75% or any other appropriate percent) utilization rate, and/or other balances. The target user data may also correspond to long term user data indicative of long term risk factors, such as a number of months of delinquency (e.g., 3 or more months or any other number of months), a number of months since a last default, a ratio of transaction declines in a time frame (e.g., last 12 months or any other appropriate period of time), a number of months since a 1 month delinquency (e.g., for live accounts), etc.

The model may be trained to predict, from the input features, a probability of default at the future time frame for the target user, which may further be used to place the target user in a risk quantile (e.g., decile, percentile, etc.). As illustrated in FIG. 3, risk quantiles considered low risk (e.g., quantiles 1-3) may be considered for credit approval. Moreover, within the approved quantiles, a credit line determination (e.g., between a high credit line and a low credit line) may be based on the risk quantile, with lower risk quantiles being recommended for higher credit lines. In some examples, users (e.g., borrowers seeking credit) may be categorized into the risk quantiles based on users' credit risk profiles. The risk quantiles may be used for allocation of credit limits and/or interest rates. For instance, users with lower assessed risk (e.g., categorized into a low risk quantile) may receive higher credit limits and lower interest rates, whereas higher-risk users (e.g., categorized into a higher risk quantile) may receive lower credit limits and/or higher interest rates. In addition, regular reviews and adjustments of credit lines may be conducted to align with changes in borrower risk profiles. Accordingly, using risk quantiles as described herein may allow responsible lending, regulatory compliance, and risk management, which may further foster transparency and fairness in a lending process.

Although binary classification allows efficient predictions that may be used for credit decisions, being limited to a single future time period may not allow for changes in default risk over time for users. For example, a given user may default early (e.g., at 6 months) and later (e.g., at 12 or 18 months) remain in default or cure the default, or alternatively may not default early, but default later. In other words, using the binary classification may limit risk strategies as users that may change default risk (e.g., users that would cure default) may be treated as if no changes are expected over time. For more flexible strategies, multiple time periods may be considered. However, having a separate binary classification model for each desired time period may become cost and resource prohibitive, as well as may require managing which data is input into which model.

As described herein, a multi-label neural network may be trained to classify multiple labels corresponding to multiple time periods, allowing use of a single model rather than multiple models. The single model may learn multiple behaviors rather than requiring a separate model for each behavior. More specifically, the single model may learn multiple risk probabilities over multiple future time periods from tabular input data (e.g., that may be normalized as described further below). Evaluating a user's credit risk probabilities over multiple time periods allows for more nuanced and robust analysis of credit risk. For instance, predicting credit risk at a single time period (such as from a binary classification model described above) may limit analysis to a simple probability without allowing analysis of how the probability may change over time. In other words, when analyzing credit risk at the single time period, a user having a credit risk that could be predicted to rise over time and another user having a credit risk that could be predicted to fall over time could have a same risk probability at the single time period. Without the additional analysis over multiple time periods, these two users could be labelled the same despite divergent potential outcomes over time.

FIG. 4 illustrates an example neural network 400 that may correspond to machine learning module 108 and/or implemented with system 100, server 206, and/or computing device 202. As illustrated in FIG. 4, neural network 400 may include an input layer 452, an output layer 456, and multiple hidden layers (e.g., a hidden layer 454A, a hidden layer 454B) interconnected therebetween. Each layer (e.g., input layer 452, hidden layer 454A, hidden layer 454B, and/or output layer 456) may include various iterations of node 458.

Each node 458 may act as its own linear regression model having input data, weights, biases/thresholds, and outputs. Each node 458 may apply appropriate weights and biases, and if the result satisfies an activation threshold (which may correspond to a node in a next layer) the result may be sent as an input to the corresponding node in the next layer. As illustrated in FIG. 4, each node 458 may be fully interconnected with every node in the next layer. Based on corresponding activation thresholds, a given node 458 may send its result to the corresponding next node. Thus, input features may be input into input layer 452 (e.g., each feature or value corresponding to each node 458 in input layer 452) which when processed through hidden layer 454A and hidden layer 454B, may be output to output layer 456. Although FIG. 4 illustrates a simplified example, in other examples neural network 400 may include additional layers, nodes, connections, etc.

Each node 458 of output layer 456 may correspond to a different label/classification. In FIG. 4, neural network 400 is a multi-label neural network for two labels, although in other examples more labels may be included. In some examples, a label value may be a probability (e.g., from 0 to 1) that the label applies although in other examples, a label value may be true/false (e.g., 0/1) that the label applies.

The weights, biases, and/or thresholds may be determined through training. For instance, a training data set may include input values associated with desired output labels. The training data set may be input into neural network 400, the resulting output compared to the desired output, and an error (between the resulting output and the desired output) backpropagated through neural network 400 to update weights, biases, thresholds, etc. as needed. In some examples, one or more hidden layers (e.g., hidden layer 454A and/or hidden layer 454B) may act as feature detection layers or otherwise be normalization layers. Feature detection layers may include nodes that may combine inputs to convert raw data inputs from input layer 452 into values that are mathematically and/or computationally easier to process. Normalization layers may include nodes for scaling inputs into ranges that may also be mathematically and/or computationally easier to process. The feature detection layers and/or normalization layers may include weights and biases that correspond to features or other statistical relationships between certain input nodes that may be developed during training.

When establishing a multi-label neural network for tabular data such as financial data and/or other user data, as opposed to other examples described above (e.g., image data, natural language, etc., in which raw input data may not initially be easy to process), the multi-label neural network may be more efficiently configured, as will be described further below. With tabular data, such as financial data and/or other user data, each of the input features may already be formatted such that feature detection may not be needed. Moreover, tabular data may be readily preprocessed to normalize values. Accordingly, the multi-label neural network for tabular data may not require feature detection and/or normalization layers.

FIG. 5 illustrates an example neural network 500, corresponding to neural network 400, that may further correspond to machine learning module 108 and/or implemented with system 100, server 206, and/or computing device 202. More specifically, neural network 500 may correspond to a multi-label shallow neural network for tabular data. As used herein, the term “shallow neural network” may refer to, in some examples, a neural network having an input layer, an output layer, and a few hidden layers, and more specifically a single hidden layer such that the shallow neural network may be a three-layer neural network. Neural network 500 may include an input layer 552 (corresponding to input layer 452), an output layer 556 (corresponding to output layer 456), and a hidden layer 554 (corresponding to hidden layer 454A or hidden layer 454B). Each layer (e.g., input layer 552, output layer 556, and/or hidden layer 554) may include various iterations of a node 558 (corresponding to node 458). Each iteration of node 558 may act as its own linear regression (or other mathematical) model having input data, weights, biases/thresholds, and outputs as illustrated in FIG. 5.

In FIG. 5, input layer 552 may include various input features. For instance, when the tabular data corresponds to user data, the input features may include a short term factor 562, a short term factor 564, a long term factor 566, and a long term factor 568 that may correspond to values from the tabular data (e.g., each input feature corresponding to a column of the tabular data such that short term factor 562, short term factor 564, long term factor 566, and long term factor 568 may collectively correspond to a row of the tabular data). The classifications or labels may correspond to various time periods for predicting risk probabilities and may include a short term label 572, a mid-term label 574, and a long term label 576. Although FIG. 5 illustrates a simplified example, in other examples neural network 500 may include additional inputs, labels, nodes, connections, etc.

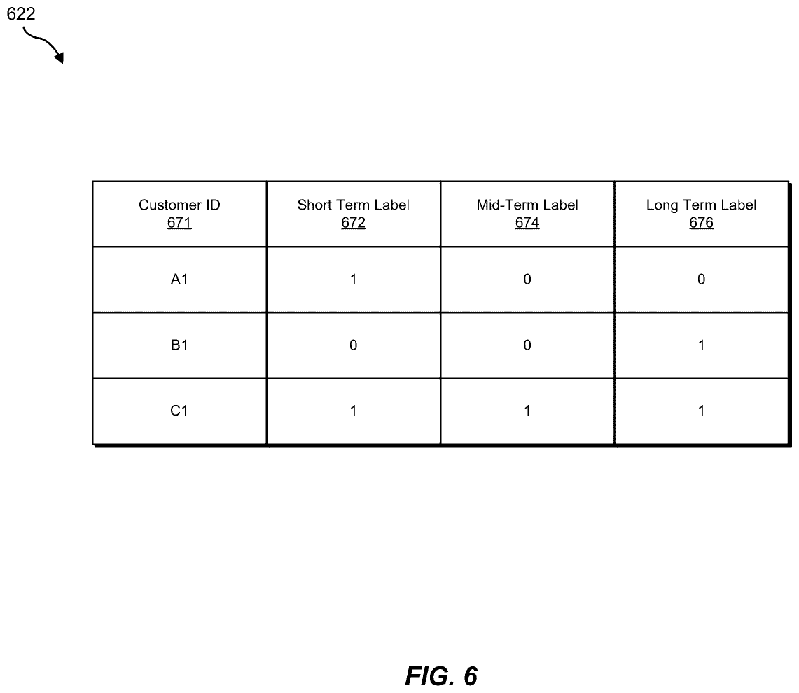

In some examples, neural network 500 may be configured to categorize multiple financial and/or risk labels and more specifically to predict a risk probability such as default risk at a short term (e.g., 6 months in the future or any other appropriate time period), a mid-term (e.g., 12 months in the future or any other appropriate time period after the short term), and a long term (e.g., 18 months in the future or any other appropriate time period after the mid-term), corresponding respectively to short term label 572, mid-term label 574, and long term label 576. Neural network 500 may be trained using training data, an example of which is illustrated in FIG. 6.

FIG. 6 illustrates example training data 622 (corresponding to training data 122) that may be used for training neural network 500. As illustrated in FIG. 6, training data 622 may include a user ID 671 for identifying existing users, a short term label 672 (corresponding to short term label 572) that indicates whether the user defaulted in the short term, a mid-term label 674 (corresponding to mid-term label 574) that indicates whether the user defaulted in the mid-term, and a long term label 676 (corresponding to long term label 576) that indicates whether the user defaulted in the long term, such that the various outputs may show a predicted change over time (e.g., change in risk probabilities over time). In FIG. 6, the values for each label may be “0” or “1” indicating certainty (e.g., 0% or 100%) of whether default occurred, although neural network 500 may output probabilities (e.g., values from 0 to 1) for short term label 572, mid-term label 574, and/or long term label 576.

Although not explicitly shown in FIG. 6, training data 622 may include historical user data used as input features (corresponding to short term factor 562, short term factor 564, long term factor 566, and/or long term factor 568) for each user ID 671. In some examples, the historical user data may include short term risk data (e.g., financial factors relevant for short term determinations) and long term risk data (e.g., financial factors relevant for long term determinations), as described above. For instance, short term risk data may correspond to short term financial data indicative of short term risk factors, such as time (e.g., months) from opening a most recent account, a number of new accounts in a time frame (e.g., last 12 months), a number of revolving accounts with a certain (e.g., 75%) utilization rate, and/or other balances. Long term risk data may correspond to long term financial data indicative of long term risk factors, such as a number of months of delinquency (e.g., 3 or more months), a number of months since a last default, a ratio of transaction declines in a time frame (e.g., last 12 months), a number of months since a 1 month delinquency (e.g., for live accounts), etc. The various risk data variables may, in some examples, correspond to independent financial features such that neural network 500 may be configured to take advantage of this independence.

As illustrated in FIG. 5, neural network 500 corresponds to a shallow neural network having three layers (e.g., with a single hidden layer). Because short term factor 562, short term factor 564, long term factor 566, and/or long term factor 568 may correspond to financial and/or risk features, these inputs may already be mathematically and/or computationally convenient to process. In some examples, the input financial variables, such as short term factor 562, short term factor 564, long term factor 566, and/or long term factor 568, may correspond to independent financial and/or risk features, such that ranges values for each may vary. Accordingly, in some examples, the input features may be preprocessed to ensure the inputs to input layer 552 are convenient to process. For example, preprocessing may include normalizing input risk data, such as by applying statistical normalization functions (e.g., applying standard scalar processing, mean distribution around values, binning into different bins, categorization, etc.), which may further include applying different combinations of functions to different risk variables. By preprocessing the input data, neural network 500 may be configured as a shallow neural network. In other words, by preprocessing the input data, neural network 500 may not require feature detection and/or normalization layers, minimizing hidden layers (e.g., to a single hidden layer 554) to optimize efficiency and performance.

As illustrated in FIG. 5, neural network 500 may include a single hidden layer that may be fully connected (e.g., each node of a layer being connected to every node of a next layer). Preprocessing the input features normalizes the input features such that input layer 552 of neural network 500 shares each of the preprocessed input features (e.g., to hidden layer 554). As further illustrated in FIG. 5, each node of hidden layer 554 may share its processed values to each node of output layer 556. Fully connecting the nodes may allow each input to be processed for each output. However, in some implementations, training may produce nodes having values having reduced relevance to a next level node such that the next level node may reduce a weight of the value received from the preceding node.

For example, short term factor 562 and short term factor 564 may be relevant to short term label 572 (and/or mid-term label 574) but not be relevant to long term label 576. Similarly, long term factor 568 and long term factor 566 may be relevant to long term label 576 (and/or mid-term label 574) but not relevant to short term label 572. Although in some implementations connections between nodes may be removed, neural network 500 may include nodes in hidden layer 554 that may apply different weights to values passed from input layer 552 to hidden layer 554 and to output layer 556 to effectively remove connections (indicated by dotted lines in FIG. 5). Preprocessing the risk variables may apply equal weight to the financial features for inputting into input layer 552. Hidden layer 554 may apply weights (e.g., via one or more node 558) that may nullify (e.g., by applying a factor of 0) the long term financial data (e.g., long term factor 566 and/or long term factor 568) for short term label 572, and may further apply weights that may nullify the short term financial data (e.g., short term factor 562 and/or short term factor 564) for long term label 576. Output layer 556 may additionally apply different weights as needed. Neural network 500 may, with additional training, update such weights as needed, allowing changing relevancies (e.g., short term financial data becoming relevant for long term label 576 and/or long term financial data becoming relevant for short term label 572) without having to reconfigure neural network 500 to reestablish connections between nodes.

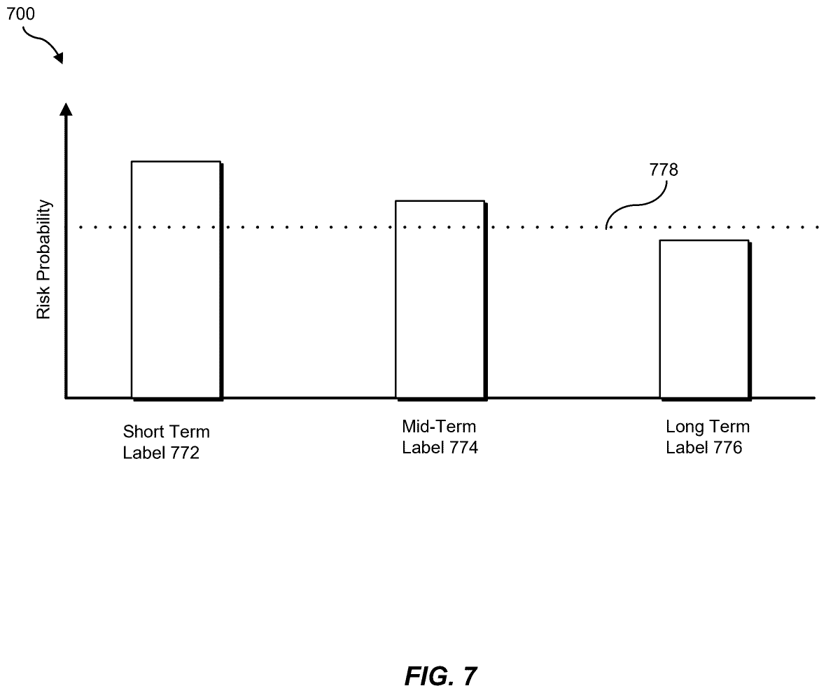

Once neural network 500 is trained (e.g., using preprocessed training data such as training data 122 and/or training data 622) neural network 500 may receive input data such as input data 124, corresponding to target user data of a target user, for predicting risk labels such as risk probabilities of the target user. In some examples, input data 124 may be preprocessed similar to training data 122 as described above, such that input data 124 may include preprocessed financial variables of the target user. Neural network 500 may output short term label 572, mid-term label 574, and/or long term label 576 that may be used for a financial strategy/decision such as determining a risk strategy for the target user based on the risk probabilities, as will be discussed further in reference to FIG. 7.

FIG. 7 illustrates a graph 700 of multi-label output of a neural network such as neural network 500. FIG. 7 includes a short term label 772 (corresponding to short term label 572), a mid-term label 774 (corresponding to mid-term label 574), and a long term label 776 (corresponding to long term label 576). As illustrated in FIG. 7, each of short term label 772, mid-term label 774, and long term label 776 may represent risk probabilities that may correspond to default risks at different time periods, (e.g., 6, 12, and 18 months, respectively, although in other examples, other successive time periods of any appropriate gaps therebetween may be used).

By having multiple output labels, a target user's change in default risk over time may be evaluated. In some examples, a user may be an early default that cures their default (see, also, user A1 in FIG. 6), a late defaulter (see, also, user B1 in FIG. 6), or an early defaulter that remained in default (see, also, user C1 in FIG. 6). In some examples, the target user may be accordingly categorized, which may further correspond to risk quantiles as in FIG. 3. In some examples, the labels may be compared against a threshold such as a risk threshold 778 for categorizing the target user, (e.g., risk threshold 778 corresponding to an acceptable risk probability such as 30% or any other appropriate risk probability, which in some examples may be dynamically determined).

A credit determination (e.g., an approved credit line) for the target user may be based on the categorization of the target user, in some examples, be based on a favorable change of default risk over the time periods. For example, FIG. 7 may indicate a target user that may be predicted to default early, but cure their default (e.g., to an acceptable risk level corresponding to an acceptable risk probability such as 30% or any other appropriate risk probability). In some examples, the acceptable risk level and/or acceptable risk probability thresholds (as further referred to herein) may be determined from a retrospective analysis on historical data, such as credit-related data. In addition, the acceptable risk level and/or acceptable risk probability thresholds may further account for potential loss based on risk. In some examples, the risk probability values of short term label 772, mid-term label 774, and/or long term label 776 themselves, trends in changes, magnitudes of changes, etc. may factor into the credit line determination. Moreover, the credit strategy may further include increasing credit (e.g., for users predicted to improve default risk) and/or otherwise adjust the credit line over time based on the predicted default risks. Accordingly, inputting input data 124 into neural network 500 may be used for credit determination of the target user.

In one example, tabular data may be input into input layer 552, such as values for short term factor 562, short term factor 564, long term factor 566, and long term factor 568, corresponding to a target user. These values may be preprocessed, as described herein, such that each of short term factor 562, short term factor 564, long term factor 566, and long term factor 568 may send their respective input value with no or minimal processing (e.g., application of weights) to hidden layer 554. FIG. 5 illustrates a fully-connected network such that each node 558 sends its value to each node 558 of hidden layer 554, although in other examples certain connections may be omitted.

Each node 558 of hidden layer 554 may combine and/or transform the values received from short term factor 562, short term factor 564, long term factor 566, and long term factor 568 by applying, for instance, weights determined through training. As described herein, certain received values may be more or less relevant for a given node 558 and/or next level node 558 such that appropriate weights (e.g., 0 or close to 0 for less relevant and greater than 1 for more relevant values) may be applied to each value, and the weighted values may be mathematically combined for sending to a next level node. As illustrated in FIG. 5, as a fully-connected network each node 558 of hidden layer 554 may send its output value to every node 558 of output layer 556.

Each node 558 of output layer 556 may combine and/or transform the values received from the nodes of hidden layer 554 by applying, for example, weights determined through training. As described herein, certain values may be less relevant and nullified (indicated by “0” in FIG. 5) and/or other appropriate weights may be applied. After applying the appropriate weights to each received value, and mathematically combining the weighted values, each of short term label 572, mid-term label 574, and long term label 576 may output a respective final output value (e.g., a probability value and more specifically a risk probability value for the corresponding label). Because the training produces weights for the various iterations of node 558 for at least hidden layer 554 and output layer 556, neural network 500 may be configured to learn multiple behaviors (e.g., the multiple labels) using the whole set of financial values, rather than requiring separate models for each label and selecting subsets of the financial values for each separate model.

Moreover, neural network 500 may be configured and/or trained for other types of tabular data that may advantageously be efficiently configured as described herein. Neural network 500 may be trained for risk probability labels relevant in other types of financial decisions. For example, neural network 500 may be trained to predict, based on attributes of a transaction and/or group of transactions, probabilities of the transaction(s) matching different types of fraudulent transactions.

FIG. 8 is a flow diagram of an exemplary computer-implemented method 800 for a multi-label shallow neural network for tabular data. The steps shown in FIG. 8 may be performed by any suitable computer-executable code and/or computing system, including the system(s) illustrated in FIGS. 1 and/or 2. In one example, each of the steps shown in FIG. 8 represent an algorithm whose structure includes and/or is represented by multiple sub-steps, examples of which will be provided in greater detail below.

As illustrated in FIG. 8, at step 802 one or more of the systems described herein may normalize tabular data corresponding to a query target. For example, normalization module 104 may normalize input data 124.

The systems described herein may perform step 802 in a variety of ways. In one example, normalization module 104 may normalize input data 124 using normalization functions including one or more of a mean distribution around a reference value, a scalar operation, data binning, and/or category consolidation.

At step 804 one or more of the systems described herein may input the normalized tabular data into a shallow neural network corresponding to a fully-connected three-layer model comprising an input layer, a hidden layer, and an output layer. Normalizing the tabular data may replace feature detection for the shallow neural network. For example, system 100 (e.g., physical processor 130) may input normalized input data 124 into machine learning module 108.

The systems described herein may perform step 804 in a variety of ways. In some examples, normalizing the tabular data allows an absence of normalization layers in the shallow neural network, as described above.

In some examples, the tabular data may correspond to independent features and the hidden layer applies weights that zero out one or more of the independent features for sending to at least one of the plurality of nodes of the output layer. For example, in FIG. 5, hidden layer 554 may include one or more node 558 that may zero out one or more of the independent features (e.g., one or more of short term factor 562, short term factor 564, long term factor 566, and/or long term factor 568) for sending to at least one of nodes 558 of output layer 556. In addition, in some examples at least one node 558 of output layer 556 may apply weights that zero out one or more values received from hidden layer 554.

In some examples, the tabular data may correspond to financial and/or risk variables of a target user, such as for determining credit risk. In some examples, the tabular data may correspond to financial transaction data, such as for detecting fraudulent transactions.

As described above, the shallow neural network (e.g., neural network 500) may be trained using normalized tabular training data (e.g., training data 122) and a training metric. In some examples, the training metric may correspond to one or more hyperparameters for the shallow neural network. In some examples, the training metric may be tuned based on a weighted loss function that prioritizes a first classification of the plurality of classifications (e.g., one or more of short term label 572, mid-term label 574, and/or long term label 576).

At step 806 one or more of the systems described herein may predict a plurality of classifications for the query target. A plurality of nodes of the output layer may respectively correspond to the plurality of classifications. For example, machine learning module 108 may predict one or more labels for the query target.

The systems described herein may perform step 806 in a variety of ways. In some examples, the plurality of classifications may correspond to probabilities of credit risk at a corresponding plurality of times (see, e.g., FIG. 5). In such examples, method 800 may further include determining a credit approval for the target user based on the plurality of classifications.

In some examples, the plurality of classifications may correspond to probabilities of matching a plurality of fraudulent transaction types. In such examples, method 800 may further include determining whether the query target corresponds to a fraudulent transaction based on the probabilities.

As detailed above, the systems and methods described herein provide an efficient neural network for predicting multiple labels from tabular data. As described herein, preprocessing input tabular data allows configuring a shallow neural network that may improve computing performance (e.g., by reducing a number of operations as compared to a deeper neural network having more hidden layers). Fully connecting the layers may allow efficient application of weights as well as more robust training that may provide improved classifications by fully utilizing values.

Moreover, in some contexts, the multi-label shallow neural network may improve certain aspects of determining and/or applying strategies based on multiple labels. For instance, as opposed to using a single future time period for predicting default risk, which may further be limited to a binary 0/1 classification, the multi-label shallow neural network described herein may allow different strategies that may consider multiple future time periods as well as further customization of strategies. Accordingly, the systems and methods described herein may allow more efficient computation as applied to a great number of users and their corresponding data.

Although the examples described herein refer to credit applications, the multi-label shallow neural network described herein may be used in other contexts. For instance, the multi-label shallow neural network may be used for customer segmentation such that the tabular data may correspond to user information (e.g., demographic information, transaction information, etc.) and the multiple labels may correspond to customer attributes and preferences (e.g., interests, topics, etc.) that may be used for tailoring marketing campaigns. In another example, the multi-label shallow neural network may be used for product recommendations such that the tabular data may correspond to user information and the multiple labels may correspond to products (e.g., specific products and/or product types) that may interest a user. In yet another example, the multi-label shallow neural network may be used for fraud detection, such that the tabular data may correspond to user transaction data (e.g., information on transactions conducted and user attributes) and the multiple labels may correspond to different types of fraud (e.g., unauthorized activity, spoofing, scamming, etc.), allowing parallel detection of the different types of fraud while learning inter-correlations between the different types. Moreover, the multi-label shallow neural network may be applied to any combination of labels described herein, which may allow learning of inter-correlations between a variety of labels, given similar input tabular data.

In one implementation, a system for a multi-label shallow neural network for tabular data may include a processor, and a non-transitory computer-readable medium having stored thereon instructions that are executable by the processor to cause the system to perform operations. The operations may include (i) preprocessing input features corresponding to target financial data of a target user, (ii) inputting the preprocessed input features into a trained shallow neural network, wherein the trained shallow neural network is trained using preprocessed training input features corresponding to historical financial data of existing users, the trained shallow neural network is trained to predict risk probabilities corresponding to a plurality of time periods to show a change in risk over time, and the trained shallow neural network corresponds to a fully-connected model comprising an input layer, a hidden layer, and an output layer without a normalization layer, (iii) outputting, by the output layer of the trained shallow neural network, the plurality of risk probabilities for the target user, and (iv) determining a risk strategy for the target user based on the plurality of risk probabilities.

In some examples, the input features include short term financial data and long term financial data and a first output from the output layer uses only the short term financial data and a second output from the output layer uses only the long term financial data. In some examples, the hidden layer applies weights that zero out the long term financial data for the first output and the hidden layer applies weights that zero out the short term financial data for the second output.

In some examples, preprocessing the input features normalizes the input features such that the input layer of the trained shallow neural network shares each of the preprocessed input features. In some examples, the plurality of risk probabilities correspond to default risks at each of the plurality of time periods and the risk strategy corresponds to a credit determination corresponding to an approved credit line for the target user based on a favorable change of default risk over the corresponding plurality of time periods.

In some examples, the above-described method may be encoded as computer-readable instructions on a non-transitory computer-readable medium. For example, a computer-readable medium includes one or more computer-executable instructions that, when executed by at least one processor of a computing device, causes the computing device to (i) preprocess financial variables of a target user, (ii) provide the preprocessed financial variables to a trained shallow neural network that is trained to provide a plurality of financial labels, wherein the trained shallow neural network corresponds to a fully-connected three-layer model and nodes of a final layer of the trained shallow neural network correspond to the plurality of financial labels, and (iii) predict each of the plurality of financial labels for the target user.

In some examples, the financial variables correspond to independent financial features and preprocessing the financial variables applies equal weight to the independent financial features for inputting into a first layer of the trained shallow neural network. In some examples, a final layer of the shallow neural network applies different weights to values as passed from the first layer to a second layer and to the final layer.

In some examples, the plurality of financial labels correspond to a change in default risk over time and the instructions include instructions for applying each of the predicted plurality of financial labels to categorize the target user based on the change in default risk over time as at least one of, an early defaulter that cured default, a late defaulter, and an early defaulter that remained in default. In some examples, the instructions include instructions for determining a credit line for the target user based on the categorization of the target user.

In one implementation, a computer-implemented method for a multi-label shallow neural network for tabular data includes (i) normalizing tabular data corresponding to a query target (ii) inputting the normalized tabular data into a shallow neural network corresponding to a fully-connected three-layer model comprising an input layer, a hidden layer, and an output layer, wherein normalizing the tabular data replaces feature detection for the shallow neural network, and (iii) predicting a plurality of classifications for the query target, wherein a plurality of nodes of the output layer respectively correspond to the plurality of classifications.

In some examples, normalizing the tabular data corresponds to at least one of a mean distribution around a reference value, a scalar operation, data binning, and category consolidation. In some examples, normalizing the tabular data allows an absence of normalization layers in the shallow neural network.

In some examples, the tabular data corresponds to independent features and the hidden layer applies weights that zero out one or more of the independent features for sending to at least one of the plurality of nodes of the output layer. In some examples, at least one node of the output layer applies weights that zero out one or more values received from the hidden layer.

In some examples, the shallow neural network is trained using normalized tabular training data and a training metric. In some examples, the training metric corresponds to one or more hyperparameters for the shallow neural network. In some examples, the training metric is tuned based on a weighted loss function that prioritizes a first classification of the plurality of classifications.

In some examples, the tabular data corresponds to financial variables of a target user, the plurality of classifications correspond to probabilities of credit risk at a corresponding plurality of times, and the method further comprises determining a credit approval for the target user based on the plurality of classifications.

In some examples, the tabular data corresponds to financial transaction data, the plurality of classifications correspond to probabilities of matching a plurality of fraudulent transaction types, and the method further comprises determining whether the query target corresponds to a fraudulent transaction based on the probabilities.

Features from any of the implementations described herein may be used in combination with one another in accordance with the general principles described herein. These and other implementations, features, and advantages will be more fully understood upon reading the following detailed description in conjunction with the accompanying drawings and claims.

As detailed above, the computing devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

Although illustrated as separate elements, the modules described and/or illustrated herein may represent portions of a single module or application. In addition, in certain implementations one or more of these modules may represent one or more software applications or programs that, when executed by a computing device, cause the computing device to perform one or more tasks. For example, one or more of the modules described and/or illustrated herein represent modules stored and configured to run on one or more of the computing devices or systems described and/or illustrated herein. In some implementations, a module may be implemented as a circuit or circuitry. One or more of these modules may also represent all or portions of one or more special-purpose computers configured to perform one or more tasks.

In addition, one or more of the modules described herein transforms data, physical devices, and/or representations of physical devices from one form to another. For example, one or more of the modules recited herein receives tabular data to be transformed, transforms the data, outputs a result of the transformation to predict multiple labels, uses the result of the transformation to determine strategies, and stores the result of the transformation to apply the multiple labels. Additionally, or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and may be varied as desired. For example, while the steps illustrated and/or described herein are shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
a processor; and
a non-transitory computer-readable medium having stored thereon instructions that are executable by the processor to cause the system to perform operations comprising:
preprocessing input features corresponding to target financial data of a target user;
inputting the preprocessed input features into a trained shallow neural network, wherein the trained shallow neural network is trained using preprocessed training input features corresponding to historical financial data of existing users, the trained shallow neural network is trained to predict risk probabilities corresponding to a plurality of time periods to show a change in risk over time, and the trained shallow neural network corresponds to a fully-connected model comprising an input layer, a hidden layer, and an output layer without a normalization layer;
outputting, by the output layer of the trained shallow neural network, the plurality of risk probabilities for the target user; and
determining a risk strategy for the target user based on the plurality of risk probabilities.

2. The system of claim 1, wherein the input features include short term financial data and long term financial data and a first output from the output layer uses only the short term financial data and a second output from the output layer uses only the long term financial data.

3. The system of claim 2, wherein the hidden layer applies weights that zero out the long term financial data for the first output and the hidden layer applies weights that zero out the short term financial data for the second output.

4. The system of claim 1, wherein preprocessing the input features normalizes the input features such that the input layer of the trained shallow neural network shares each of the preprocessed input features.

5. The system of claim 1, wherein the plurality of risk probabilities correspond to default risks at each of the plurality of time periods and the risk strategy corresponds to a credit determination corresponding to an approved credit line for the target user based on a favorable change of default risk over the corresponding plurality of time periods.

6. A non-transitory computer-readable medium having stored thereon instructions that are executable by a processor of a computing system to cause the computing system to perform operations comprising:
preprocessing financial variables of a target user;
providing the preprocessed financial variables to a trained shallow neural network that is trained to provide a plurality of financial labels, wherein the trained shallow neural network corresponds to a fully-connected three-layer model and nodes of a final layer of the trained shallow neural network correspond to the plurality of financial labels; and
predicting each of the plurality of financial labels for the target user.

7. The non-transitory computer-readable medium of claim 6, wherein the financial variables correspond to independent financial features and preprocessing the financial variables applies equal weight to the independent financial features for inputting into a first layer of the trained shallow neural network.

8. The non-transitory computer-readable medium of claim 7, wherein a final layer of the shallow neural network applies different weights to values as passed from the first layer to a second layer and to the final layer.

9. The non-transitory computer-readable medium of claim 7, wherein the plurality of financial labels correspond to a change in default risk over time and the instructions include instructions for applying each of the predicted plurality of financial labels to categorize the target user based on the change in default risk over time as at least one of:
an early defaulter that cured default;
a late defaulter; and
an early defaulter that remained in default.

10. The non-transitory computer-readable medium of claim 9, wherein the instructions include instructions for determining a credit line for the target user based on the categorization of the target user.

11. A computer-implemented method comprising:
normalizing tabular data corresponding to a query target;
inputting the normalized tabular data into a shallow neural network corresponding to a fully-connected three-layer model comprising an input layer, a hidden layer, and an output layer, wherein normalizing the tabular data replaces feature detection for the shallow neural network; and
predicting a plurality of classifications for the query target, wherein a plurality of nodes of the output layer respectively correspond to the plurality of classifications.

12. The method of claim 11, wherein normalizing the tabular data corresponds to at least one of:
a mean distribution around a reference value;
a scalar operation;
data binning; and
category consolidation.

13. The method of claim 11, wherein normalizing the tabular data allows an absence of normalization layers in the shallow neural network.

14. The method of claim 11, wherein the tabular data corresponds to independent features and the hidden layer applies weights that zero out one or more of the independent features for sending to at least one of the plurality of nodes of the output layer.

15. The method of claim 11, wherein at least one node of the output layer applies weights that zero out one or more values received from the hidden layer.

16. The method of claim 11, wherein the shallow neural network is trained using normalized tabular training data and a training metric.

17. The method of claim 16, wherein the training metric corresponds to one or more hyperparameters for the shallow neural network.

18. The method of claim 16, wherein the training metric is tuned based on a weighted loss function that prioritizes a first classification of the plurality of classifications.

19. The method of claim 11, wherein the tabular data corresponds to financial variables of a target user, the plurality of classifications correspond to probabilities of credit risk at a corresponding plurality of times, and the method further comprises determining a credit approval for the target user based on the plurality of classifications.

20. The method of claim 11, wherein the tabular data corresponds to financial transaction data, the plurality of classifications correspond to probabilities of matching a plurality of fraudulent transaction types, and the method further comprises determining whether the query target corresponds to a fraudulent transaction based on the probabilities.
